(19) United States
(12) Patent Application Publication
(10) Pub. No.: US 2015/0276323 A1
(43) Pub. Date: Oct. 1, 2015

(54) HEAT PIPE AND PROCESS FOR MANUFACTURING THE SAME

(71) Applicant: OSRAM GMBH, München (DE)

(72) Inventors: Hao Li, Shenzhen Guangdong (CN); Xiaomian Chen, Shenzhen Guangdong (CN); Yangang Cheng, Shenzhen (CN); Peng Chen, Shenzhen (CN)

(21) Appl. No.: 14/377,509

(22) PCT Filed: Feb. 28, 2013
(86) PCT No.: PCT/EP2013/054037

§ 371 Date: Aug. 8, 2014

(30) Foreign Application Priority Data
Mar. 1, 2012 (CN) 201210052184.7

(51) Int. Cl. F28D 15/04; B29C 65/08; B23P 15/26; F28F 21/04

(52) U.S. Cl. CPC F28D 15/04; F28F 21/04; B29C 65/08; B23P 15/26

(57) ABSTRACT

A heat pipe may include a tube body, a capillary structure provided on an inner wall of the tube body, and a cooling liquid accommodated in the tube body. The tube body and the capillary structure are made of thermal conductive plastic, respectively.

### RELATED APPLICATIONS

The present application is a national stage entry according to 35 U.S.C. §371 of PCT application No.: PCT/EP2013/054037 filed on Feb. 28, 2013, which claims priority from Chinese application No.: 201210052184.7 filed on Mar. 1, 2012, and is incorporated herein by reference in its entirety.

### TECHNICAL FIELD

Various embodiments relate to a heat pipe, and a process for manufacturing the pipe.

### BACKGROUND

Currently, heat pipes are widely used as normal thermal conductive components in several industries and in daily life. The principle of the heat pipe technology is to transfer heat by making use of evaporation and condensation of a cooling liquid. After the cooling liquid is injected into a vacuum tube body, the liquid keeps cycling inside the tube body in an evaporation-condensation phase change process, to frequently transfer the heat at the heating end to the condensation end, so as to form a heat transfer process of transferring heat from one end of the tube body to the other end of the tube body.

In the heat pipe, the condensation process of the cooling liquid is achieved based on the capillary action. The capillary structure mainly serves the functions of providing a passage for the liquid from the condensation end to the evaporation end, providing a passage for thermal conduction between the inner wall and the liquid/vapor, and providing pores that are needed for the liquid/vapor to generate capillary force. There are four kinds of capillary structures, viz. mesh, groove, sintered powder, and fiber. The heat pipe in the prior art is usually made of a metal such as copper. Thus, such heat pipe has poor electrical insulation. In addition, with the restriction of the manufacturing process, the copper heat pipes commercially available are substantially straight, and the users need to carry out further processing on the heat pipes according to the situation, for example, bending, pressing or winding. However, this will destroy the capillary structure inside the heat pipes, and thereby will greatly decrease the thermal conductivity of the heat pipes. Further, as copper has strong rigidity, it is very difficult to bend the heat pipe at an acute angle. A high sintering temperature, such as 900° C.-1000° C., is required in manufacturing a heat pipe by means of sintering, which means mass energy consumption.

### SUMMARY

Various embodiments provide a novel heat pipe, which has high design flexibility, is simple to manufacture, is low in cost, has superior heat dissipation performance, and has superior continuous capillary structure and electrical insulation.

The heat pipe according to various embodiments may include a tube body, a capillary structure provided on an inner wall of the tube body, and a cooling liquid accommodated in the tube body, characterized in that, the tube and the capillary structure are made of thermal conductive plastic. Since the novel heat pipe is made of thermal conductive plastic, its shape is not limited to a linear shape, but is varied. Specifically, the tube body made of thermal conductive plastic can be easily processed into a predetermined shape (for example, by means of a mold having a suitable shape). In this way, the heat pipe can be designed high flexibly.

According to various embodiments, the tube body and the capillary structure are joined together through the ultrasonic welding technology. The capillary structure provided on the inner wall of the tube body can be integrated with the tube body through the ultrasonic welding technology, and it is unlike the bending processing of the traditional metal heat pipe, which destroys the internal capillary structure. In this way, good continuity of the capillary structure in the heat pipe can be ensured. In addition, the ultrasonic welding technology is particularly suitable for joining together materials of the same type, for example, plastic and plastic, under low temperatures, which thereby can reduce the manufacturing cost.

According to various embodiments, the capillary structure is fabricated by an anomalous thermal conductive plastic powder. “anomalous” here means that the shape of the powder is irregular, for example, the shape for different powder is indefinite and varied. The anomalous shape of the powder can avoid that the gaps in the capillary structure made from the powder are too uniform, which thereby can increase the inherent capillary force of the capillary structure.

According to various embodiments, the tube body includes a first half tube and a second half tube, the capillary structure includes a first capillary portion and a second capillary portion provided on inner walls of the first half tube and of the second half tube, respectively, the first half tube and the first capillary portion are joined together through the ultrasonic welding technology to form a first half heat pipe, and the second half tube and the second capillary portion are joined together through the ultrasonic welding technology to form a second half heat pipe. This processing manner of section by section enables, for example, linear-shaped half tubes or half tubes bent at an angle. Preferably, the capillary structure is disposed on the inner wall of each half tube through the ultrasonic welding technology, which ensures that the capillary structure is continuous and is completely connected with the half tubes so as to form, for example, half heat pipes bent at an angle.

According to various embodiments, the first and second half heat pipes are joined together through the ultrasonic welding technology.

According to various embodiments, the first and second half tubes each is molded through the ultrasonic welding technology. For example, it is feasible to place the thermal conductive plastic powder in the mold, and subsequently mold it into a half tube structure through the ultrasonic welding technology. In the manufacture of the heat pipe according to the present disclosure, by means of the unified welding technology, the steady performance of the heat pipe can be ensured and the manufacture tolerance can be reduced.

According to various embodiments, the first and second half tubes each include a first portion and a second portion, wherein the first portion and the second portion are inclined with respect to each other. That is to say, the first portion and the second portion are interconnected via a connecting portion bent at an angle. In this design solution, a bent half tube structure can be achieved, which thereby meets particular application needs.

According to various embodiments, the thermal conductive plastic includes one of a micro-scale or nano-scale metal, ceramic, graphite, and organic material, or a combination thereof. Preferably, the ceramic is one or more selected from a group consisting of Al₂O₃, Si, and AlN. The thermal conductive plastic made from these materials has high thermal conductivity, for example, in a range of 1-20 W/m*K. This kind of thermal conductive plastic requires a relatively low molding temperature, and has the advantages of low density, low electrical conductivity or electrical insulation, and so on.

Various embodiments further provide a process for manufacturing the above heat pipe, including:

a) providing first and second half tubes and powder, the first and second half tubes and the powder are made of thermal conductive plastic, respectively;
b) providing a first mold, pressing the powder onto inner walls of the first and second half tubes, respectively, to forma first capillary portion and a second capillary portion, joining the first and second half tubes with the first and second capillary portions, respectively, to form a first half heat pipe and a second half heat pipe; and
c) providing a second mold, pressing the first and second half heat pipes together, and joining the first and second half heat pipes together to form a complete tube body and a capillary structure provided on an inner wall of the tube body.

In the manufacturing method according to various embodiments, for example, in order to obtain a heat pipe bent at an angle, it is feasible to provide half tubes bent at an angle first, and then integrate the powder directly on the inner walls of the half tubes. In this way, a continuous capillary structure is formed, and the extending of the capillary structure is completely matched to the shape of the half tubes, such that the occurrence of breakdown of the capillary structure, for example, at the bend of the half tube will be prevented.

According to various embodiments, after the step c), the process further includes:

d) vacuumizing the tube body and injecting a cooling liquid into the tube body; and
e) sealing the tube body.

According to various embodiments, in the step a), the first and second half tubes are manufactured through the ultrasonic welding technology. During the whole manufacturing process, by means of the unified ultrasonic welding technology, the steady performance of the heat pipe can be ensured and the manufacture tolerance can be reduced.

According to various embodiments, in the step b), the first and second half tubes with the first and second capillary portions are joined, respectively, through the ultrasonic welding technology.

According to various embodiments, in the step c), the first and second half heat pipes are joined together through the ultrasonic welding technology.

In the above manufacturing process, the working parameters of the ultrasonic welding machine are, for example,

frequency: 15-40 kHz;
pressure range: 0.2-1 MPa (which can be slightly greater than this according to the practical situation); and
working pressure: not greater than 5 kg/cm² (which can be slightly greater than this according to the practical situation).

According to various embodiments, in the step a), the first and second half tubes each include a first portion and a second portion, wherein the first portion and the second portion are inclined with respect to each other. In such design solution, a bent half tube structure can be achieved, which can meet particular application needs.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 is a 3D sectional view of the heat pipe according to the first embodiment of the present disclosure;

FIG. 2 is a sectional schematic diagram of the heat pipe according to the second embodiment of the present disclosure;

FIG. 3 is a flow chart of the manufacturing method according to the present disclosure; and

FIG. 4 is a schematic diagram of step b) in FIG. 3.

### DETAILED DESCRIPTION

The following detailed description refers to the accompanying drawing that show, by way of illustration, specific details and embodiments in which the disclosure may be practiced.

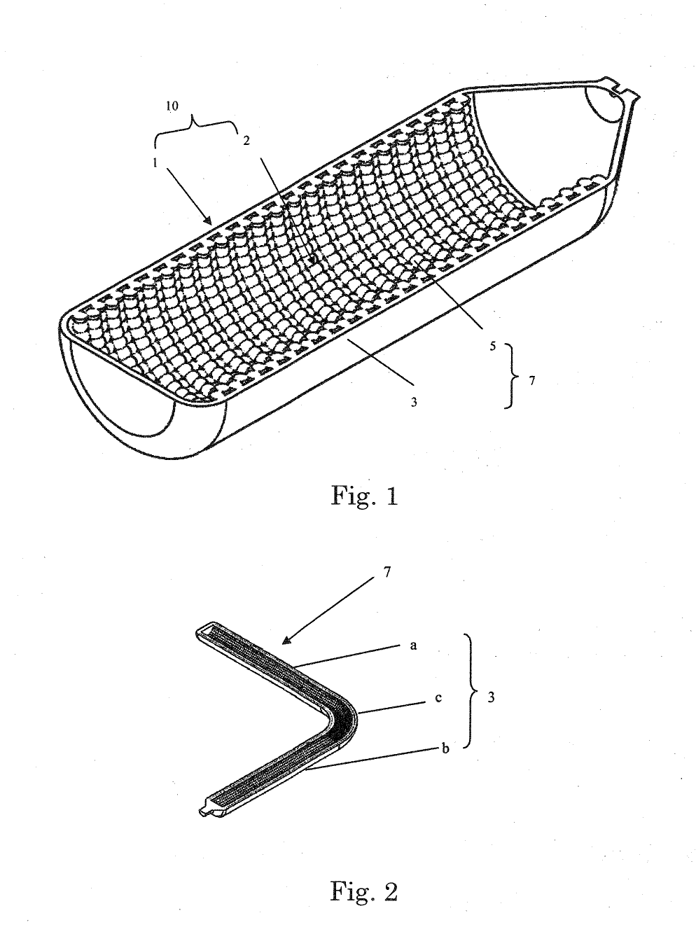

FIG. 1 is a 3D sectional view of the heat pipe 10 according to the first embodiment of the present disclosure. As can be seen from the figure, the heat pipe 10 made of thermal conductive plastic according to the present disclosure includes a tube body 1 and a capillary structure 2 provided on an inner wall of the tube body 1. The heat pipe 10 can be comprised of a first half heat pipe 7 and a second half heat pipe 8 which have identical structure. For the sake of clarity, only the first half heat pipe 7 is shown. The first and second half heat pipes 7, 8 can be joined through the ultrasonic welding technology to forma complete heat pipe 10. The following description on the first half heat pipe 7 is also applicable to the second half heat pipe 8. In the present disclosure, the cooling liquid can be, for example, water.

The first half heat pipe 7 includes a first half tube 3 and a first capillary portion 5 provided on an inner wall of the first half tube 3. According to the present disclosure, the powder fabricating the capillary structure 2, for example, the first capillary portion 5, is an anomalous thermal conductive plastic powder. At the time of forming a capillary structure, the pores of the anomalous powder are different from each other, which can increase the capillary force of the capillary structure.

FIG. 2 is a sectional schematic diagram of the heat pipe 10 according to the second embodiment of the present disclosure, wherein the structure of the heat pipe 10 bent at an angle is schematically explained. Similar to FIG. 1, only the first half heat pipe 7 is taken as an example for the description. The first half tube 3 of the first half heat pipe 7 includes a first portion a and a second portion b, wherein the first portion a and the second portion b are interconnected via a connecting portion c bent at an angle. For example, by means of a mold having a suitable shape, the thermal conductive plastic powder can be directly processed, through the ultrasonic welding technology, into the first half tube 3 having the above shape. The users can simply predetermine the shape of the half tube, viz. heat pipe, according to the use conditions, without any need to bend or press a linear heat pipe, which thereby can prevent the capillary structure in the heat pipe from being destroyed.

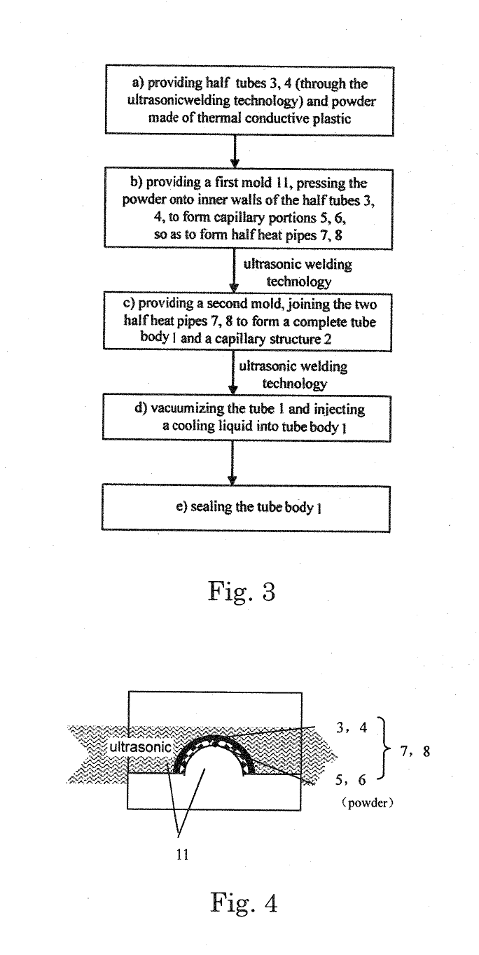

FIG. 3 is a flow chart of the manufacturing method according to the present disclosure. Firstly, according to step a), the thermal conductive plastic powder is manufactured into half tubes 3, 4 having a predetermined shape by an ultrasonic welding machine, and a certain amount of thermal conductive plastic powder is provided; in step b), the thermal conductive plastic powder is pressed onto the inner walls of the half tubes 3, 4 using a first mold 11, to form capillary portions 5, 6, and then the half tubes 3, 4 and the capillary portions 5, 6 are integrated by the ultrasonic welding machine, so as to form half heat pipes 7, 8; and in step c), the two half heat pipes 7, 8 are pressed together by using a second mold, and are welded by the ultrasonic welding machine, to form a complete tube body 1. Secondly, as described in step d) and step e), the tube body 1 is vacuumized and the cooling liquid is injected into the tube body 1. Finally, the tube body 1 is sealed to form the heat pipe 10 of the present disclosure.

FIG. 4 is a schematic diagram of step b) in FIG. 3. The thermal conductive plastic powder can be pressed onto the inner walls of the half tubes 3, 4 by using, for example, the first mold 11 having an arch-shaped upper surface, so as to form the capillary portions 5, 6 always in contact with the inner walls of the half tubes 3, 4, and then the half tubes 3, 4 and the capillary portions 5, 6 are welded together by the ultrasonic welding machine. The half heat pipes 7, 8 formed in this way, in particular the capillary portions 5, 6 therein, have superior continuity.

In the scope of the present disclosure, the thermal conductive plastic involved includes one of a micro-scale or nano-scale metal, ceramic, graphite, and organic material, or a combination thereof, wherein the ceramic can be one or more selected from a group consisting of Al₂O₃, Si, and AlN. The working parameters of the ultrasonic welding machine are, for example,

frequency: 15-40 kHz;
pressure range: 0.2-1 MPa (which can be slightly greater than this according to the practical situation); and
working pressure: not greater than 5 kg/cm² (which can be slightly greater than this according to the practical situation).

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

### LIST OF REFERENCE SIGNS

1 tube body
2 capillary structure
3 first half tube
4 second half tube
5 first capillary portion
6 second capillary portion
7 first half heat pipe
8 second half heat pipe
10 heat pipe
11 first mold
a first portion
b second portion
c connecting portion

1. A heat pipe comprising:
a tube body,
a capillary structure provided on an inner wall of the tube body, and
a cooling liquid accommodated in the tube body,
wherein the tube body and the capillary structure are made of thermal conductive plastic, respectively.

2. The heat pipe according to claim 1,
wherein the tube body and the capillary structure are joined together through the ultrasonic welding technology.

3. The heat pipe according to claim 2,
wherein the capillary structure is fabricated by an anomalous thermal conductive plastic powder.

4. The heat pipe according to claim 1,
wherein the tube body comprises a first half tube and a second half tube, the capillary structure comprises a first capillary portion and a second capillary portion provided on inner walls of the first half tube and of the second half tube, respectively, the first half tube and the first capillary portion are joined together through the ultrasonic welding technology to form a first half heat pipe, and the second half tube and the second capillary portion are joined together through the ultrasonic welding technology to form a second half heat pipe.

5. The heat pipe according to claim 4,
wherein the first and second half heat pipes are joined together through the ultrasonic welding technology.

6. The heat pipe according to claim 4,
wherein the first and second half tubes each is molded through the ultrasonic welding technology.

7. The heat pipe according to claim 6,
wherein the first and second half tubes each comprise a first portion and a second portion, wherein the first portion and the second portion are inclined with respect to each other.

8. The heat pipe according to claim 1,
wherein the thermal conductive plastic comprises one of a micro-scale or nano-scale metal, ceramic, graphite, and organic material, or a combination thereof.

9. The heat pipe according to claim 8,
wherein the ceramic is one or more selected from a group consisting of Al₂O₃, Si, and AlN.

10. A process for manufacturing a heat pipe, the process comprising:
providing first and second half tubes and powder, the first and second half tubes and the powder are made of thermal conductive plastic, respectively;
providing a first mold, pressing the powder onto inner walls of the first and second half tubes, respectively, to form a first capillary portion and a second capillary portion, joining the first and second half tubes with the first and second capillary portions, respectively, to form a first half heat pipe and a second half heat pipe; and
providing a second mold, pressing the first and second half heat pipes together, and joining the first and second half heat pipes together to form a complete tube body and a capillary structure provided on an inner wall of the tube body.

11. The process according to claim 10, further comprising, following said providing the second mold:
vacuumizing the tube body and injecting a cooling liquid into the tube body; and
sealing the tube body.

12. The process according to claim 10,
wherein in said providing first and second half tubes and powder, the first and second half tubes are manufactured through the ultrasonic welding technology.

13. The process according to claim 10,
wherein in said providing the first mold, the first and second half tubes with the first and second capillary portions are joined, respectively, through the ultrasonic welding technology.

14. The process according to claim 10,
wherein in said providing the second mold, the first and second half heat pipes are joined together through the ultrasonic welding technology.

15. The process according to claim 12,
wherein an ultrasonic frequency of the ultrasonic welding technology is 15-40 kHz.

16. The process according to claim 10,
wherein in said providing the first and second half tubes and powder, the first and second half tubes each comprise a first portion and a second portion, wherein the first portion and the second portion are inclined with respect to each other.

17. The process according to claim 13, wherein an ultrasonic frequency of the ultrasonic welding technology is 15-40 kHz.

18. The process according to claim 14, wherein an ultrasonic frequency of the ultrasonic welding technology is 15-40 kHz.
